(19) United States
(12) Patent Application Publication
(10) Pub. No.: US 2025/0224522 A1
(43) Pub. Date: Jul. 10, 2025

(54) Using Global Navigation Satellite Systems to Detect Access Point Environments

(71) Applicant: Cisco Technology, Inc., San Jose, CA (US)

(72) Inventors: Niloo Bahadori, Greensboro, NC (US); Arya Fallahi, Oberengstingen (CH); Ardalan Alizadeh, Campbell, CA (US); Peiman Amini, Fremont, CA (US); Jerome Henry, Pittsboro, NC (US); Sachin D. Wakudkar, St-Sulpice (CH); Matthew Silverman, Shaker Heights, OH (US); Roberto Muccifora, Ropraz (CH); Amine Choukir, Ecublens (CH)

(21) Appl. No.: 18/409,686

(22) Filed: Jan. 10, 2024

(51) Int. Cl. G01S 19/45; H04W 4/029

(52) U.S. Cl. CPC G01S 19/45; H04W 4/029

(57) ABSTRACT

Described herein are devices, systems, methods, and processes for determining the indoor or outdoor status of an access point (AP) utilizing global navigation satellite system (GNSS) data. In many embodiments, a machine learning model is trained and utilized to distinguish between indoor, outdoor, and partially covered areas based on GNSS data features. In a number of embodiments, geometric inference is utilized to deduce the indoor or outdoor status of the AP from the relative direction of satellites that are detectable or not detectable. In a variety of embodiments, the indoor or outdoor status of the AP is inferred based on an obstacle profile constructed based on satellites that are simultaneously detectable by two or more APs. The standalone solution provides an automated approach for determining the indoor or outdoor status of an AP without relying on external services.

The present disclosure relates to wireless communication. More particularly, the present disclosure relates to utilizing global navigation satellite system (GNSS) data to determine the indoor or outdoor status of an access point (AP).

### BACKGROUND

Wireless communication networks utilize access points (APs) to provide connectivity to various devices. The APs can be installed in various environments, including indoor and outdoor settings. The placement of these APs is important as it can significantly impact the performance and coverage of the wireless network.

Conventionally, the determination of whether an AP is located indoors, or outdoors is often manual or based on user input during setup. This approach can lead to inaccuracies if the user is unsure or makes an error during input. Furthermore, manual input does not account for potential changes in the AP's environment over time.

Regulations such as those set by the automatic frequency coordination (AFC) stipulate that indoor APs should not be used outdoors. This makes the accurate determination of the environment of an AP important for compliance. However, the present solutions do not provide a reliable, automated mechanism for determining the environment of an AP. Moreover, because customers may not want to rely on external services due to security concerns or cost considerations, there is a need for a standalone solution that can determine the environment of an AP without relying on external services.

### SUMMARY OF THE DISCLOSURE

Systems and methods for utilizing GNSS data to determine the indoor or outdoor status of AP in accordance with embodiments of the disclosure are described herein. In some embodiments, at least one network interface controller is configured to provide access to a network, and a memory communicatively coupled to the processor, wherein the memory includes a management logic that is configured to collect a first global navigation satellite system (GNSS) dataset associated with a first network device; and determine an indoor-or-outdoor status of the first network device based on the collected first GNSS dataset.

In some embodiments, to determine the indoor-or-outdoor status of the first network device, the management logic is further configured to identify one or more features in the collected first GNSS dataset, and the indoor-or-outdoor status of the first network device is determined based on applying a machine learning process to the identified one or more features.

In some embodiments, one or more features include one or more of a signal attribute, a carrier-to-noise density ratio (C/N0), a number of observable satellites, a number of decodable satellites, pseudorange measurement noise statistics, or a pseudorange residual.

In some embodiments, the machine learning process is associated with a model.

In some embodiments, the model includes a classifier.

In some embodiments, the model is pretrained based on supervised learning.

In some embodiments, the model is pretrained based on unsupervised learning.

In some embodiments, the management logic is further configured to update the model based on locally collected data.

In some embodiments, to determine the indoor-or-outdoor status of the first network device, the management logic is further configured to determine zero, one, or more angle ranges within which at least one satellite is detectable at the first network device based on the collected first GNSS dataset, and the indoor-or-outdoor status of the first network device is determined based on the zero, one, or more angle ranges.

In some embodiments, the determined indoor-or-outdoor status of the first network device includes an outdoor environment status if the zero, one, or more angle ranges includes at least one angle range that satisfies a criterion.

In some embodiments, the determined indoor-or-outdoor status of the first network device includes an indoor environment status if the zero, one, or more angle ranges includes one or more angle ranges a widest of which is less than a threshold.

In some embodiments, the determined indoor-or-outdoor status of the first network device includes an indoor environment status if the zero, one, or more angle ranges includes zero angle range.

In some embodiments, to determine the indoor-or-outdoor status of the first network device, the management logic is further configured to collect a second GNSS dataset associated with a second network device, identify one or more satellites that are simultaneously detectable by the first network device and the second network device based on the collected first GNSS dataset and the collected second GNSS dataset, each of the one or more satellites being simultaneously detectable by the first network device and the second network device over a respective period of time, determine one or more unobstructed zones based on each of the one or more satellites being simultaneously detectable by the first network device and the second network device, and construct an obstacle profile based on a plurality of unobstructed zones, the plurality of unobstructed zones including the one or more unobstructed zones determined based on each of the one or more satellites, wherein the indoor-or-outdoor status of the first network device is determined based on the constructed obstacle profile.

In some embodiments, wherein based on each of the one or more satellites being simultaneously detectable by the first network device and the second network device, the one or more unobstructed zones are determined based further on satellite location data, a distance between the first network device and the second network device, and a triangulation technique.

In some embodiments, the distance between the first network device and the second network device is based on a radio frequency ranging measurement between the first network device and the second network device.

In some embodiments, the obstacle profile is constructed based further on one or more first satellites that are successively but not simultaneously detectable by the first network device and the second network device.

In some embodiments, the network device and the first network device are co-located at a same device.

In some embodiments, the network device and the first network device are separate devices.

In some embodiments, at least one network interface controller is configured to provide access to a network, and a memory communicatively coupled to the processor, wherein the memory includes a management logic that is configured to collect a first global navigation satellite system (GNSS) dataset associated with a first network device, identify one or more features in the collected first GNSS dataset, and determine an indoor-or-outdoor status of the first network device based on applying a machine learning process to the identified one or more features.

In some embodiments, a method for managing a network device includes collecting a first global navigation satellite system (GNSS) dataset associated with the network device, and determine an indoor-or-outdoor status of the network device based on the collected first GNSS dataset.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of an artificial neural network in accordance with various embodiments of the disclosure;

FIG. 2 is a diagram illustrating a process for determining the indoor or outdoor status of a network device in accordance with various embodiments of the disclosure;

FIG. 3 is a diagram illustrating various scenarios for determining the indoor or outdoor status of a network device based on satellite detectability;

FIG. 4 is a diagram illustrating a process for determining the indoor or outdoor status of a network device based on GNSS satellite detection continuity in accordance with various embodiments of the disclosure;

FIG. 5 is a flowchart showing a process for determining the indoor or outdoor status of a network device in accordance with various embodiments of the disclosure;

FIG. 6 is a flowchart showing a process for determining the indoor or outdoor status of a network device based on a machine learning process in accordance with various embodiments of the disclosure;

FIG. 7 is a flowchart showing a process for determining the indoor or outdoor status of a network device in accordance with various embodiments of the disclosure;

FIG. 8 is a flowchart showing a process for determining the indoor or outdoor status of a network device in accordance with various embodiments of the disclosure; and

FIG. 9 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that utilize global navigation satellite system (GNSS) data to automatically determine the indoor or outdoor status of an access point (AP). The solution may be standalone and may not need external services to identify the indoor or outdoor status, addressing the needs of customers who may not have access to or prefer not to enable external services due to security or cost concerns. In many embodiments, a machine learning model (or simply “model” hereinafter) (e.g., a classifier) may be trained based on GNSS data. In a number of embodiments, the GNSS data can include one or more features that may include, but are not limited to, GNSS signal attributes, such as, but not limited to, the carrier-to-noise density ratio (C/N0) (e.g., L1 C/N0 and/or L5 C/N0), the number of observable or detected satellites, the number of decodable satellites (i.e., the number of satellites used to calculate the position solution), pseudorange measurement noise statistics (e.g., GPGST_RMS), and/or pseudorange residuals. In a variety of embodiments, statistics of the features can be extracted. Examples of the statistics may include, but are not limited to, mean, variance, quartile deviation, skewness, and/or Kurtosis. In some embodiments, based on the statistics, the features that correlate the best with the different indoor or outdoor status of the device can be selected and utilized to train the machine learning model. The selection of the features can be based on their statistical significance and their ability to differentiate between indoor and outdoor environments.

Experiments have shown that the probability density function of each of the number of decodable satellites, the sum of the C/N0 value that is greater than a threshold, and the pseudorange residual may have different peaks at different locations (values) depending on whether the device containing the GNSS sensor/receiver is in an indoor environment, in an outdoor environment, or in a partially covered environment. In particular, the number of decodable satellites is likely to be higher, high C/N0 values are more likely, and the pseudorange residuals are likely to be lower when the network device is in an outdoor environment compared to an indoor environment (because walls and ceilings obstruct signals), with the partially covered environment representing an intermediate scenario. In other words, a machine learning model (e.g., a classifier) can be trained to utilize these features (and/or the statistics relating to these features) to distinguish between the indoor or outdoor statuses of devices. These parameters may be chosen due to their sensitivity to changes in the indoor or outdoor statuses. In more embodiments, the training phase can be a supervised learning process, where labeled data may be utilized to train the machine learning model. In additional embodiments, the training phase can include an unsupervised learning process, where unlabeled data may be utilized to train the machine learning model. In further embodiments, the training phase can include a semi-supervised learning process, where both labeled data and unlabeled data may be utilized to train the machine learning model. In still more embodiments, at deployment, the (pre-) trained model can be updated or fine-tuned based on locally collected data to account for idiosyncrasies that may be present in the environment (e.g., edge cases specific to the locale) where the model is deployed. By way of a non-limiting example, the locally collected data can be labeled ground truth data provided by a user (e.g., a system administrator).

In still further embodiments, to determine the indoor or outdoor status of a network device (e.g., an AP), GNSS data may be collected from the GNSS receiver/sensor of the network device. Features in the GNSS data that are associated with the (pre-) trained model can be identified. Utilizing the model, a machine learning process may be applied to the features (and/or statistics relating to the features) to obtain a determination of the indoor or outdoor status of the network device. In still additional embodiments, the machine learning process can be executed at the network device itself. In some more embodiments, the machine learning process may be executed at another device (e.g., a controller) that is separate from the network device.

In certain embodiments, the indoor or outdoor status of a network device may be deduced based on one or more GNSS satellites being detectable or not detectable by the network device. Based on ephemeris data (which can be transmitted by each of the GNSS satellites), when signals from a satellite is decoded by the network device, the network device can determine the orbital location of the satellite and thus the direction (angle) of the satellite in relation to the network device. Therefore, over a period of time, the network device may identify one or more angle ranges within which one or more satellites are detectable by the network device. In particular, the network device may identify the angle ranges by analyzing the direction of the satellites over time, utilizing the ephemeris data transmitted by each satellite. In yet more embodiments, the network device can infer an angle range within which a satellite is detectable based simply on the fact that the satellite is continuously detectable over a corresponding period of time as the satellite travels along the orbit. In general, a satellite may be detectable when there is a line-of-sight (LOS) between the network device and the satellite; and a satellite may not be detectable when there is no LOS between the network device and the satellite. Accordingly, angle ranges within which satellites are detectable can be assumed to correspond to open air, windows, open doors, and so on, whereas angle ranges within which no satellite is detectable may be assumed to correspond to walls, ceilings, floors, and so on. The indoor or outdoor status of a network device can therefore be determined based on the angle ranges within which one or more satellites are detectable or not detectable. Therefore, in still yet more embodiments, if a network device can detect a satellite over a wide angle range (e.g., an azimuth range that is close to 360 degrees) (i.e., such an angle range may satisfy a criterion (e.g., being greater than a threshold)), it may be determined that the network device is in an outdoor environment. In many further embodiments, if a network device can detect a satellite over a wide angle range, but cannot detect any satellites at other angles, it may be determined that the network device is in an outdoor environment but is close to one or more strong obstacles in one or more directions. In many additional embodiments, if a network device can detect satellites within just one or a few a narrow angle ranges (i.e., the widest such angle range may be less than a threshold), it may be determined that the network device is in an indoor environment where one or a few windows are present. In still yet further embodiments, if a network device cannot detect any satellites at any angle (i.e., there is zero angle range within which a satellite is detectable), it may be determined that the network device is in an indoor environment. In still yet additional embodiments, the determination of the indoor or outdoor status of the network device can be performed at the network device itself. In several embodiments, the determination of the indoor or outdoor status of the network device may be performed at another device (e.g., a controller) that is separate from the network device.

In several more embodiments, the indoor or outdoor status of a network device may be inferred based on GNSS satellite detection continuity. In numerous embodiments, if two GNSS-network devices located at a suitable distance apart from each other can simultaneously (jointly) detect a GNSS satellite over a definite period of time (over which the satellite travels through an orbit segment), an unobstructed zone (which can correspond to open air, a window, an open door, and so on) in relation to the two network devices can be identified based on this fact. A zone may be deemed unobstructed if the two network devices cannot possibly detect the satellite simultaneously over the period of time otherwise. In numerous additional embodiments, the two network devices can communicate with each other (e.g., utilizing wireless communication) to help at least one of the two network devices determine the satellites detectable by the other network device. In further additional embodiments, the two network devices may each transit indications of detectable satellites at the respective network device to a third device, where the third device can determine the satellites detectable by the other network device. In some embodiments, the unobstructed zone can be identified utilizing triangulation techniques based on ephemeris data and the distance between the two network devices. In more embodiments, the distance between the two network devices may be identified based on a radio frequency (RF) ranging technique. The orbit segment can correspond to a respective GNSS satellite angle range in relation to each of the two network devices. Accordingly, in additional embodiments, the unobstructed zone may be determined based at least in part on the GNSS satellite angle ranges in relation to the two network devices corresponding to the orbit segment. In further embodiments, further unobstructed zones can be identified based on simultaneous detection of additional satellites by the two network devices over respective periods of time. In still more embodiments, an obstacle profile indicative of obstacles around and between the two network devices may be created based on the identified unobstructed zones. In still further embodiments, the obstacle profile may be based further on successive but not simultaneous detection of satellites by the two network devices. In still additional embodiments, more detailed obstacle profiles in relation to three or more network devices can also be created based on a similar process. In some more embodiments, the indoor or outdoor status of a network device may be determined based on the obstacle profile. In certain embodiments, the determination of the indoor or outdoor status of a network device can be performed at one or both of the two network devices. In yet more embodiments, the determination of the indoor or outdoor status of a network device may be performed at a third device (e.g., a controller) that is separate from the two network devices.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom very large-scale integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

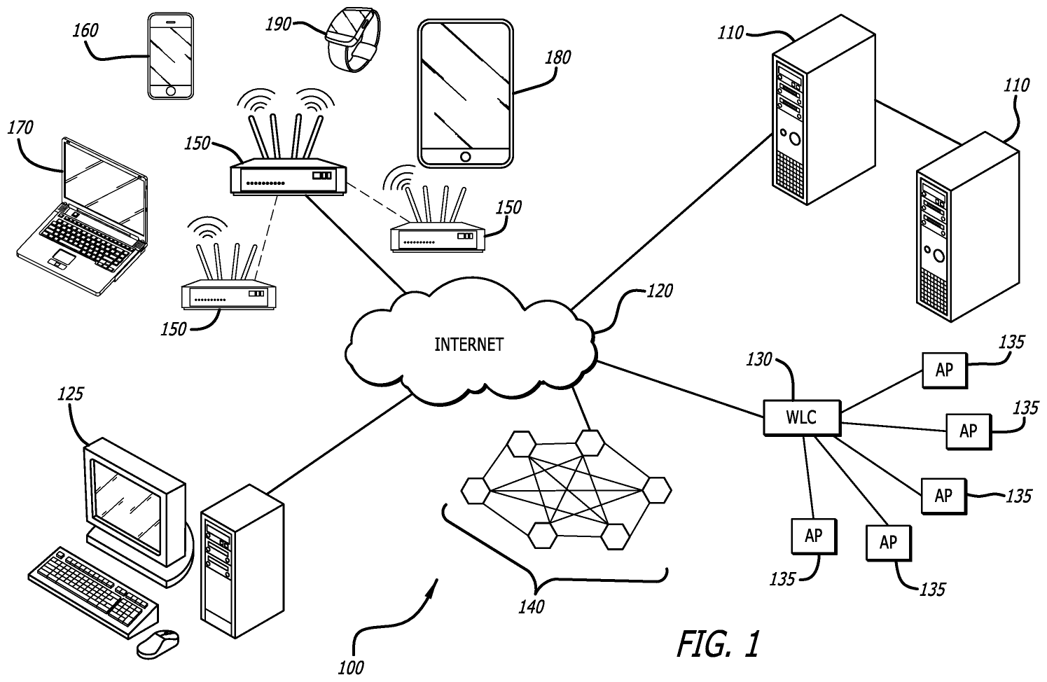

Referring to FIG. 1, a conceptual illustration of an artificial neural network 100 in accordance with various embodiments of the disclosure is shown. As those skilled in the art will recognize, various methods of machine learning models can be utilized to achieve desired outcomes efficiently. For example, some embodiments may utilize decisions trees, random forests, support vector machines, naïve Bayes, or K-nearest neighbor's algorithms. However, artificial neural networks have increased in popularity, especially in deep learning techniques where detection of complex patterns in data and the ability to solve a wide range of problems has been desired. In various embodiments, an artificial neural network may be utilized. Artificial neural networks are a type of machine learning model inspired by the structure and function of the human brain, and often consist of three main types of layers: the input layer, the output layer, and one or more intermediate (also called hidden) layers.

In many embodiments, the input layer is responsible for receiving input data, which could be anything from an image to a text document to numerical values. Each input feature can be represented by a node in the input layer. Conversely, the output layer is often responsible for producing the output of the network, which could be, for example, a prediction or a classification. The number of nodes in the output layer can depend on the task at hand. For example, if the task is to classify images into ten different categories, there would be ten nodes in the output layer, each representing a different category.

The intermediate layers are where the specialized connections are made. These intermediate layers are responsible for transforming the input data in a non-linear way to extract meaningful features that can be used for the final output. In various embodiments, a node in an intermediate layer can take as an input a weighted sum of the outputs from the previous layer, apply a non-linear activation function to it, and pass the result on to the next layer. The weights of the connections between nodes in the layers are learned during training. This training can utilize backpropagation, which may involve calculating the gradient of the error with respect to the weights and adjusting the weights accordingly to minimize the error.

At a high level, the artificial neural network 100 depicted in the embodiment of FIG. 1 includes a number of inputs 110, an input layer 120, one or more intermediate layers 130, and an output layer 140. The artificial neural network 100 may comprise a collection of connected units or nodes called artificial neurons 150, which loosely model the neurons in a biological brain. Each connection, like the synapses in a biological brain, can transmit a signal from one artificial neuron to another. An artificial neuron that receives a signal can process the signal and then trigger additional artificial neurons within the next layer of the neural network. As those skilled in the art will recognize, the artificial neural network 100 depicted in FIG. 1 is shown as an illustrative example, and various embodiments may comprise artificial neural networks that can accept more than one type of input and can provide more than one type of output.

In some embodiments, the signal at a connection between artificial neurons is a value, and the output of each artificial neuron is computed by some nonlinear function (called an activation function) of the sum of the artificial neuron's inputs. Often, the connections between artificial neurons are called “edges” or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals propagate from the first layer (the input layer 120) to the last layer (the output layer 140), possibly after traversing one or more intermediate layers (also called hidden layers) 130.

The inputs to an artificial neural network may vary depending on the problem being addressed. In object detection for example, the inputs may be data representing values for certain corresponding actual measurements or values within the object to be detected. In one embodiment, the artificial neural network 100 comprises a series of hidden layers in which each neuron is fully connected to neurons of the next layer. The artificial neural network 100 may utilize an activation function such as sigmoid, nonlinear, or a rectified linear unit (ReLU), upon the sum of the weighted inputs, for example. The last layer in the artificial neural network may implement a regression function to produce the classified or predicted classifications output for object detection as output 160. In further embodiments, a sigmoid function can be used, and the prediction may need raw output transformation into linear and/or nonlinear data.

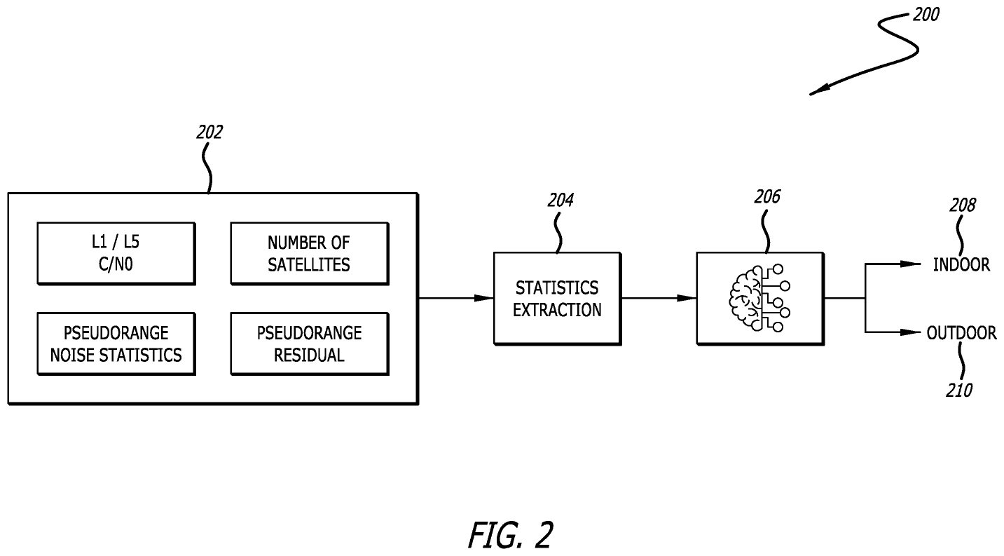

Although a specific embodiment for an artificial neural network machine learning model suitable for carrying out the various steps, processes, methods, and operations described herein is discussed with respect to FIG. 1, any of a variety of systems and/or processes may be utilized in accordance with embodiments of the disclosure. For example, the artificial neural network may be external operated, such as through a cloud-based service, or a third-party service. The elements depicted in FIG. 1 may also be interchangeable with other elements of FIGS. 2-9 as required to realize a particularly desired embodiment.

Referring to FIG. 2, a diagram 200 illustrating a process for determining the indoor or outdoor status of a network device in accordance with various embodiments of the disclosure is shown. In many embodiments, features 202 may relate to features in GNSS data. In the embodiments depicted in FIG. 2, features 202 can include GNSS signal attributes such as, but not limited to, the C/N0 for L1 and/or L5, the number of decodable satellites, pseudorange measurement noise statistics, and pseudorange residuals. In particular, pseudorange measurement noise statistics can refer to the statistical analysis of the noise or error present in the pseudorange measurements. One non-limiting example of these statistics, GPGST_RMS (global positioning system general statistics-root mean square), may be the root mean square (RMS) value of the total estimated error in the position fix provided by the global positioning system (GPS) receiver. Further, the pseudorange residuals can be the differences between the measured pseudoranges and the expected pseudoranges based on the estimated position and time of a receiver.

In a number of embodiments, the features 202 may then be passed to a statistics extraction block 204. At the statistics extraction block 204, statistics of the features 202 can be extracted. In a variety of embodiments, the statistics may include, but may not be limited to, mean, variance, quartile deviation, skewness, and/or Kurtosis. The extraction of these statistics can allow for a more detailed analysis of the features. In some embodiments, based on the statistics, features in the GNSS data may be selected based on their statistical significance and their ability to differentiate between indoor and outdoor environments.

In more embodiments, the features 202 and/or the extracted statistics may be utilized to train a machine learning model 206. In additional embodiments, the model 206 can be a classifier. In further embodiments, the model 206 may be trained utilizing a supervised, unsupervised, or semi-supervised learning process, depending on the availability of labeled and unlabeled data. The model 206 can be trained to distinguish between indoor and outdoor statuses of devices based on the features 202 and/or the extracted statistics. In still more embodiments, the model 206 may be trained to distinguish between further statuses including, but not limited to, a partially covered environment status. In still further embodiments, once trained, the model 206 can then be utilized to determine the indoor or outdoor status of a network device based on the GNSS data features and/or statistics relating to such features. In still additional embodiments, at deployment, the (pre-) trained model 206 can be updated or fine-tuned based on locally collected data to account for idiosyncrasies that may be present in the environment (e.g., edge cases specific to the locale) where the model is deployed. By way of a non-limiting example, the locally collected data can include labeled ground truth data provided by a user (e.g., a system administrator). In some more embodiments, if the model 206 determines that the device is indoors, the model may output the indoor status 208. If the model 206 determines that the device is outdoors, the model can output the outdoor status 210. In certain embodiments, depending on how the model 206 was trained, the model 206 may output one or more further statuses including, but not limited to, a partially covered environment status (not shown).

Although a specific embodiment for determining the indoor or outdoor status of a network device suitable for carrying out the various steps, processes, methods, and operations described herein is discussed with respect to FIG. 2, any of a variety of systems and/or processes may be utilized in accordance with embodiments of the disclosure. For example, the model can be trained using a combination of GNSS data and additional environmental data, such as, but not limited to, temperature or humidity, to improve the accuracy of the indoor/outdoor status determination. The elements depicted in FIG. 2 may also be interchangeable with other elements of FIGS. 1 and 3-9 as required to realize a particularly desired embodiment.

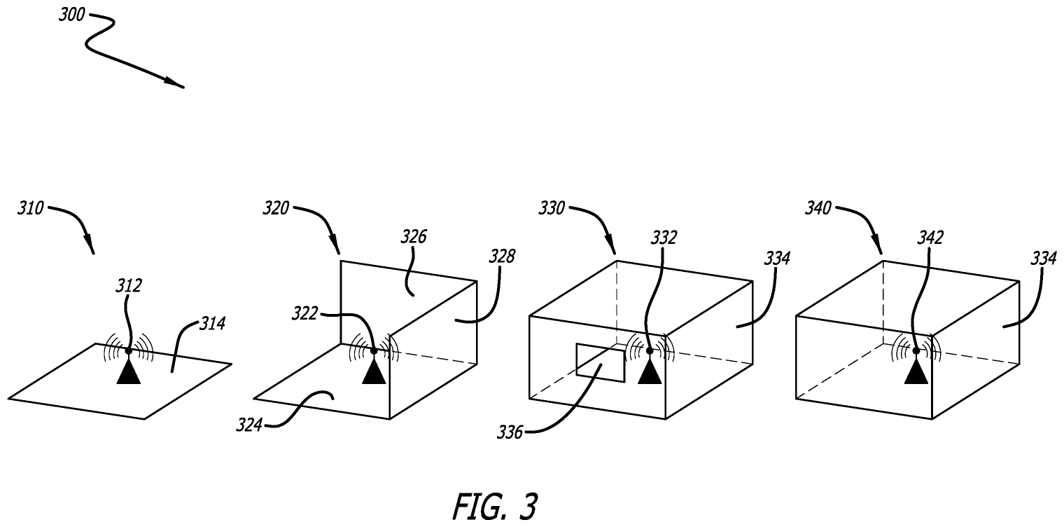

Referring to FIG. 3, a diagram 300 illustrating various scenarios for determining the indoor or outdoor status of a network device based on satellite detectability in accordance with various embodiments of the disclosure is shown. In many embodiments, the indoor or outdoor status of a network device can be deduced based on the detectability of one or more GNSS satellites by the network device. When signals from a satellite are decoded by the network device, the device can use the ephemeris data transmitted by each satellite to determine the orbital location of the satellite and thus the direction or angle of the satellite in relation to the network device. Over time, the network device can identify one or more angle ranges within which one or more satellites are detectable.

In a number of embodiments, the network device can infer an angle range within which a satellite is detectable simply based on the continuous detectability of the satellite over a corresponding period of time as the satellite travels along its orbit. Generally, a satellite may be detectable when there is an LOS between the network device and the satellite, and may not be detectable when there is no LOS. Accordingly, angle ranges within which satellites are detectable can be assumed to correspond to open air, windows, open doors, and so on, whereas angle ranges within which no satellite is detectable may be assumed to correspond to obstructions such as walls, ceilings, or floors. The indoor or outdoor status of a network device can therefore be determined based on the angle ranges within which one or more satellites are detectable or not detectable.

By way of non-limiting examples, in a variety of embodiments, the diagram 310 may depict a scenario where the network device 312 can detect one or more satellites over a wide angle range (e.g., an azimuth range that is close to 360 degrees). The wide angle range of detectability can suggest that there is an LOS to the satellite over a large area, which may be typical of an outdoor environment. Therefore, in this scenario, the network device 312 can be determined to be in an outdoor environment 314. In some embodiments, the diagram 320 may present a different scenario. Here, the network device 322 can detect one or more satellites over a wide angle range, but there may be certain angles, corresponding to walls or obstacles 326 and 328, at which no satellites are detectable. This can suggest that while the network device 322 is in an outdoor environment 324, the network device 322 may be close to one or more strong obstacles (e.g., walls or obstacles 326 and 328) in one or more directions.

In more embodiments, the diagram 330 may illustrate a scenario where the network device 332 can detect satellites within just one narrow angle range, corresponding to the window 336. The limited angle range of detectability can suggest that the network device 332 is in an indoor environment 334, where a window 336 may allow for a limited LOS to the satellites. In additional embodiments, the diagram 340 may show a scenario where the network device 342 cannot detect any satellites at any angle. The lack of satellite detectability can suggest that the network device 342 is in an indoor environment 344, likely with no windows or other openings providing any LOS to the satellites.

Although a specific embodiment for determining the indoor or outdoor status of a network device based on satellite detectability suitable for carrying out the various steps, processes, methods, and operations described herein is discussed with respect to FIG. 3, any of a variety of systems and/or processes may be utilized in accordance with embodiments of the disclosure. For example, the process may be adapted to account for the movement of the network device, using changes in satellite detectability over time to improve the accuracy of the indoor/outdoor status determination. The elements depicted in FIG. 3 may also be interchangeable with other elements of FIGS. 1, 2, and 4-9 as required to realize a particularly desired embodiment.

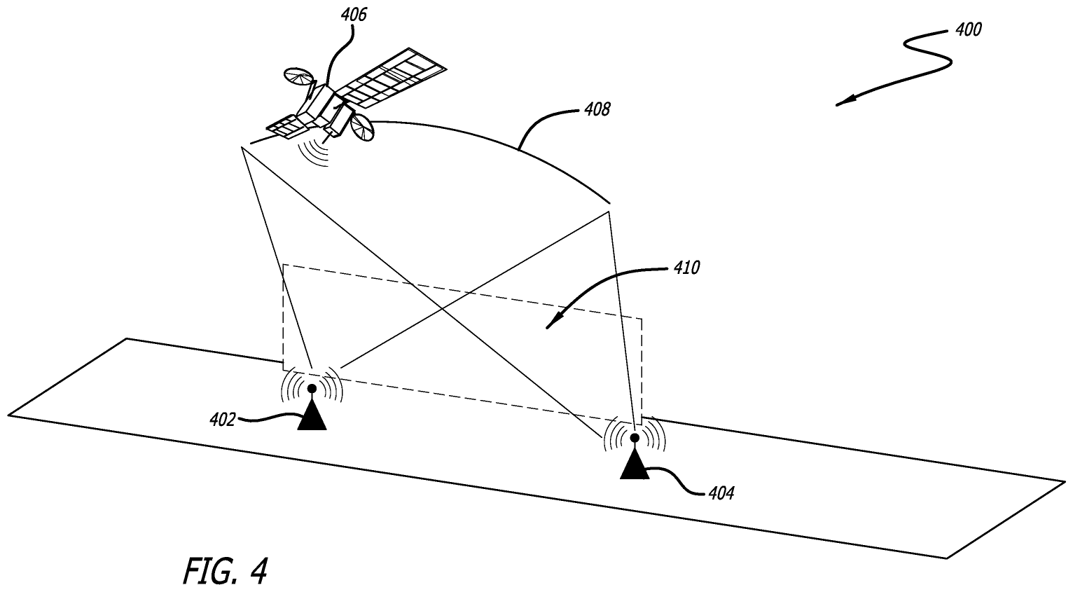

Referring to FIG. 4, a diagram 400 illustrating a process for determining the indoor or outdoor status of a network device based on GNSS satellite detection continuity in accordance with various embodiments of the disclosure is shown. In many embodiments, the indoor or outdoor status of a network device can be inferred based on the continuity of GNSS satellite detection. The process may involve two or more network devices that are within the RF range of each other. In the embodiments depicted in FIG. 4, in a number of embodiments, two network devices 402 and 404 can be within the RF range of each other. In a variety of embodiments, the distance between the two network devices 402 and 404 can be identified using an RF ranging technique.

In some embodiments, the two network devices 402 and 404 may communicate with each other, by way of non-limiting examples, using wired or wireless communication, to help at least one network device 402 or 404 to determine the satellites detectable by the other device. Accordingly, at least one network device 402 or 404 can determine the satellites that are simultaneously (jointly) and/or successively detected by the two network devices 402 and 404. In more embodiments, the two network devices 402 and 404 can each transmit indications of detectable satellites at the respective network device to another, third, device, where the third device can determine the satellites that are simultaneously (jointly) and/or successively detected by the two network devices 402 and 404. As shown in the embodiments depicted in FIG. 4, because the two network devices 402 and 404 can simultaneously (jointly) detect a GNSS satellite 406 as the GNSS satellite 406 travels from one end to the other end of the orbit segment 408, where the period during which the GNSS satellite 406 travels from one end to the other end of the orbit segment 408 may be recognized as a definite period of time by the two network devices 402 and 404, an unobstructed zone 410 can be determined. Generally, a zone may be deemed unobstructed if the two (or more) network devices cannot possibly detect the satellite simultaneously over the period of time otherwise (i.e., if the zone is obstructed). The orbit segment 408 can correspond to a respective GNSS satellite angle range in relation to each of the network devices 402 and 404. Accordingly, in additional embodiments, the unobstructed zone 410 may be determined based at least in part on the GNSS satellite angle ranges in relation to the network devices 402 and 404 corresponding to the orbit segment 408. In further embodiments, the unobstructed zone 410 can be identified using triangulation techniques based on ephemeris data and the distance between the two network devices 402 and 404. In still more embodiments, an unobstructed zone can correspond to open air, a window, an open door, and so on.

In still further embodiments, additional unobstructed zones can be identified based on simultaneous detection of additional satellites by the two network devices 402 and 404 over respective periods of time. In still additional embodiments, an obstacle profile indicative of obstacles around and between the two network devices 402 and 404 can be created based on the identified unobstructed zones including the unobstructed zone 410. In some more embodiments, the obstacle profile can be further refined based on successive but not simultaneous detection of satellites by the two network devices 402 and 404. In certain embodiments, more detailed obstacle profiles in relation to three or more network devices can also be created based on a similar process. In yet more embodiments, the indoor or outdoor status of the network device 404 or 404 can be determined based on the obstacle profile. By way of a non-limiting example, if the obstacle profile indicates that the network device 404 or 404 is surrounded by obstacles, it can be determined that the network device 404 or 404 is in an indoor environment. On the other hand, if the obstacle profile indicates that the network device 404 or 404 is surrounded by unobstructed zones, it can be determined that the network device 404 or 404 is in an outdoor environment.

Although a specific embodiment for determining the indoor or outdoor status of a network device based on GNSS satellite detection continuity suitable for carrying out the various steps, processes, methods, and operations described herein is discussed with respect to FIG. 4, any of a variety of systems and/or processes may be utilized in accordance with embodiments of the disclosure. For example, the process can be adapted to include additional sensors on the network devices, such as, but not limited to, accelerometers or barometers, to provide additional data that can enhance the accuracy of the indoor/outdoor status determination based on changes in movement or atmospheric pressure. The elements depicted in FIG. 4 may also be interchangeable with other elements of FIGS. 1-3 and 5-9 as required to realize a particularly desired embodiment.

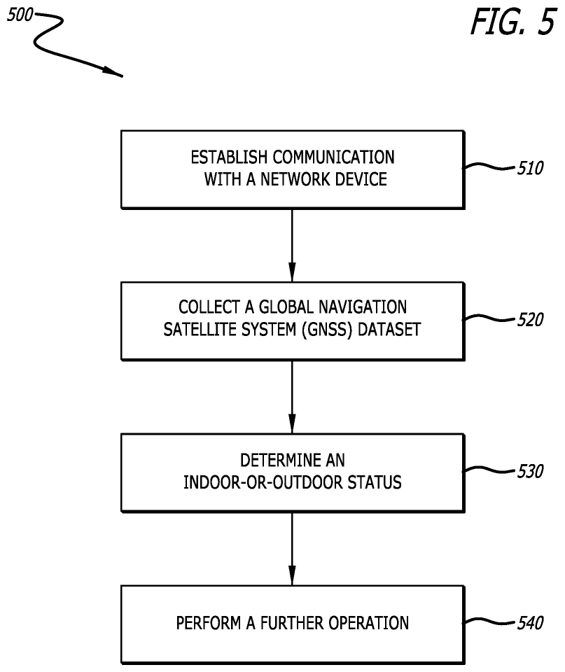

Referring to FIG. 5, a flowchart showing a process 500 for determining the indoor or outdoor status of a network device in accordance with various embodiments of the disclosure is shown. In many embodiments, the process 500 may establish communication with a network device (block 510). In a number of embodiments, establishing communication can involve initiating a connection with the network device, authenticating the device, and/or setting up a secure communication channel. In a variety of embodiments, the network device may be a separate device or co-located with the device performing the process.

In some embodiments, the process 500 may collect a GNSS dataset (block 520). In more embodiments, the GNSS dataset can include various types of data related to the GNSS signals received by (the GNSS receiver/sensor of) the network device, such as, but not limited to, signal attributes (e.g., C/N0 for one or more GNSS bands), the number of observable satellites, the number of decodable satellites, pseudorange measurement noise statistics, and/or pseudorange residuals. In additional embodiments, the collection of the GNSS dataset may be performed continuously or at specific intervals, and the data can be stored for immediate or future analysis.

In further embodiments, the process 500 may determine an indoor-or-outdoor status (block 530). In still more embodiments, an indoor-or-outdoor status of the network device can be determined based on the collected GNSS dataset. In still further embodiments, the process 500 may identify features in the GNSS dataset and apply a machine learning process to these features (and/or statistics in relation to the features) to determine the indoor or outdoor status. In still additional embodiments, the machine learning process can be associated with a model, which may be a classifier. In some more embodiments, the model may be pretrained based on supervised, unsupervised, or semi-supervise learning. In certain embodiments, the model can also be updated based on locally collected data.

In yet more embodiments, the process 500 may perform a further operation (block 540). This operation can be any action that is appropriate based on the determined indoor-or-outdoor status of the network device. In still yet more embodiments, the process 500 may adjust the operation of the network device based on its determined indoor-or-outdoor status. In many further embodiments, the process 500 can provide the status indication to another system or user for further action.

Although a specific embodiment for determining the indoor or outdoor status of a network device suitable for carrying out the various steps, processes, methods, and operations described herein is discussed with respect to FIG. 5, any of a variety of systems and/or processes may be utilized in accordance with embodiments of the disclosure. For example, the process may be adapted to include additional types of data in the GNSS dataset, such as, but not limited to, data related to the velocity of the network device or the time of day, to improve the accuracy of the indoor/outdoor status determination. The elements depicted in FIG. 5 may also be interchangeable with other elements of FIGS. 1-4 and 6-9 as required to realize a particularly desired embodiment.

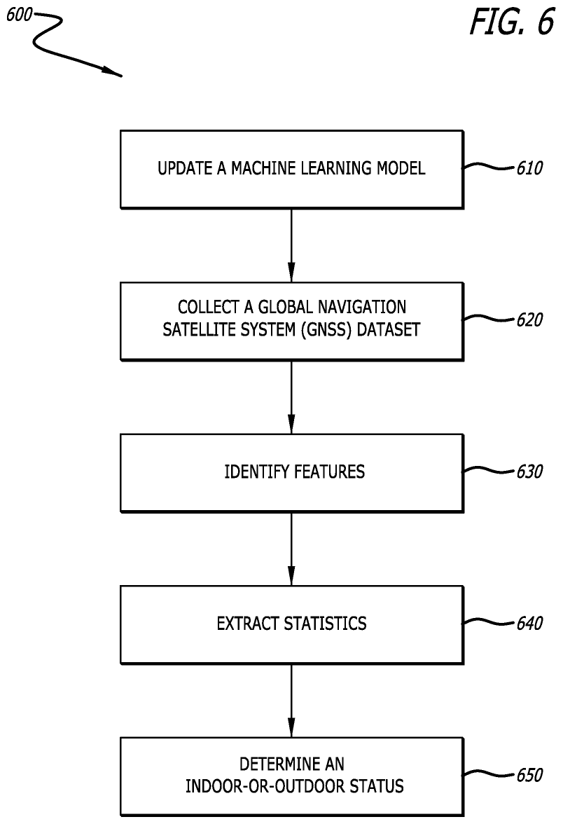

Referring to FIG. 6, a flowchart showing a process 600 for determining the indoor or outdoor status of a network device based on a machine learning process in accordance with various embodiments of the disclosure is shown. In many embodiments, the process 600 may update a machine learning model (block 610). In a number of embodiments, the machine learning model may be associated with distinguishing between indoor and outdoor statuses of a network device. In a variety of embodiments, updating the model can involve refining the pre-trained model based on new or locally collected data, adjusting the model parameters, and/or retraining the model to improve its performance. In some embodiments, the update may be performed periodically or triggered by specific events, such as, but not limited to, a significant change in the collected data.

In more embodiments, the process 600 may collect a GNSS dataset (block 620). In additional embodiments, the GNSS dataset from a network device can include various types of data related to the GNSS signals received by the network device, such as, but not limited to, signal attributes (e.g., C/N0 for one or more GNSS bands), the number of observable satellites, the number of decodable satellites, pseudorange measurement noise statistics, and/or pseudorange residuals. In further embodiments, the collection of the GNSS dataset may be performed continuously or at specific intervals, and the data can be stored for immediate or future analysis.

In still more embodiments, the process 600 may identify features (block 630). In still further embodiments, features in the GNSS dataset can be identified based on the specifications of the machine learning model to be utilized. In still additional embodiments, the identified features may be utilized directly as input to the machine learning model or can be further processed before being utilized.

In some more embodiments, the process 600 may extract statistics (block 640). In certain embodiments, this can involve calculating various statistical measures from the identified features, such as, but not limited to, mean, variance, quartile deviation, skewness, and/or Kurtosis, or other statistical measures. The statistics may be utilized to summarize the features in a compact form that can be efficiently processed by the machine learning model.

In yet more embodiments, the process 600 may determine an indoor-or-outdoor status (block 650). In still yet more embodiments, the determination can be based on the identified features and/or the extracted statistics, and the updated machine learning model. In many further embodiments, the model may utilize the identified features and/or the statistics as input and output an indication of the indoor or outdoor status of the network device. In many additional embodiments, the indication can be a binary decision (indoor or outdoor) or a probability distribution over the possible statuses.

Although a specific embodiment for determining the indoor or outdoor status of a network device based on a machine learning model suitable for carrying out the various steps, processes, methods, and operations described herein is discussed with respect to FIG. 6, any of a variety of systems and/or processes may be utilized in accordance with embodiments of the disclosure. For example, the process can be adapted to use different types of machine learning models, such as, but not limited to, neural networks, decision trees, or support vector machines, depending on the specific requirements of the application. The elements depicted in FIG. 6 may also be interchangeable with other elements of FIGS. 1-5 and 7-9 as required to realize a particularly desired embodiment.

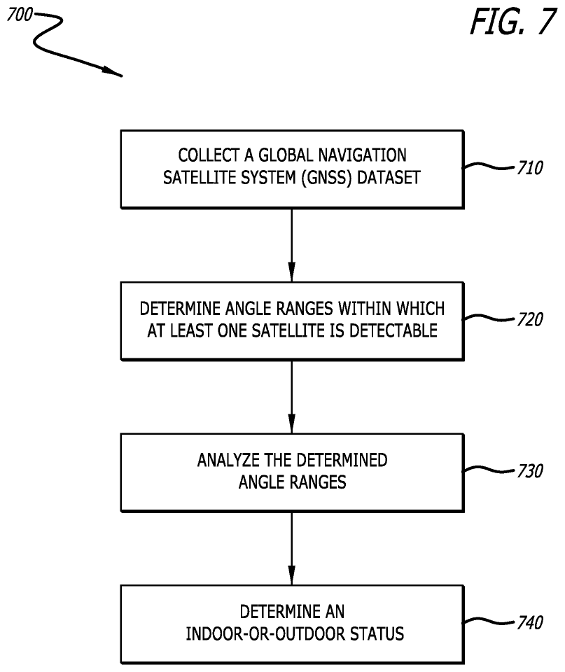

Referring to FIG. 7, a flowchart showing a process 700 for determining the indoor or outdoor status of a network device in accordance with various embodiments of the disclosure is shown. In many embodiments, the process 700 may collect a GNSS dataset (block 710). In a number of embodiments, the GNSS dataset from a network device can include various types of data related to the GNSS signals received by the network device, such as, but not limited to, indications of detected GNSS satellites, timestamps, signal attributes (e.g., C/N0 for one or more GNSS bands), the number of observable satellites, the number of decodable satellites, pseudorange measurement noise statistics, and/or pseudorange residuals. In a variety of embodiments, the collection of the GNSS dataset may be performed continuously or at specific intervals, and the data can be stored for immediate or future analysis.

In some embodiments, the process 700 may determine angle ranges within which at least one satellite is detectable (block 720). In more embodiments, this can involve analyzing the collected GNSS dataset to identify the angles at which the network device can detect satellites. The determined angle ranges may provide data about the visibility of the sky (where the GNSS satellites are located) from the location of the network device.

In additional embodiments, the process 700 may analyze the determined angle ranges (block 730). In further embodiments, analyzing the determined angle ranges can involve calculating various measures from the angle ranges, such as, but not limited to, the number of ranges, the width of the ranges, and/or the distribution of the ranges. The analysis may provide additional data about the environment around the network device, which can be useful for determining the indoor-or-outdoor status of the network device.

In still more embodiments, the process 700 may determine an indoor-or-outdoor status (block 740). In still further embodiments, the determination of the indoor-or-outdoor status of the network device can be based on the analysis of the angle ranges. By way of non-limiting examples, if the angle ranges cover a wide area of the sky, the network device may be determined to be outdoors, while if the angle ranges are narrow or non-existent, the network device can be determined to be indoors.

Although a specific embodiment for determining the indoor or outdoor status of a network device suitable for carrying out the various steps, processes, methods, and operations described herein is discussed with respect to FIG. 7, any of a variety of systems and/or processes may be utilized in accordance with embodiments of the disclosure. For example, the process can be adapted to use different types of GNSS systems, such as, but not limited to, GPS, GLONASS, and/or Galileo, or to use additional types of data, such as, but not limited to, signal strength or signal-to-noise ratio, to improve the accuracy of the angle range determination. The elements depicted in FIG. 7 may also be interchangeable with other elements of FIGS. 1-6, 8, and 9 as required to realize a particularly desired embodiment.

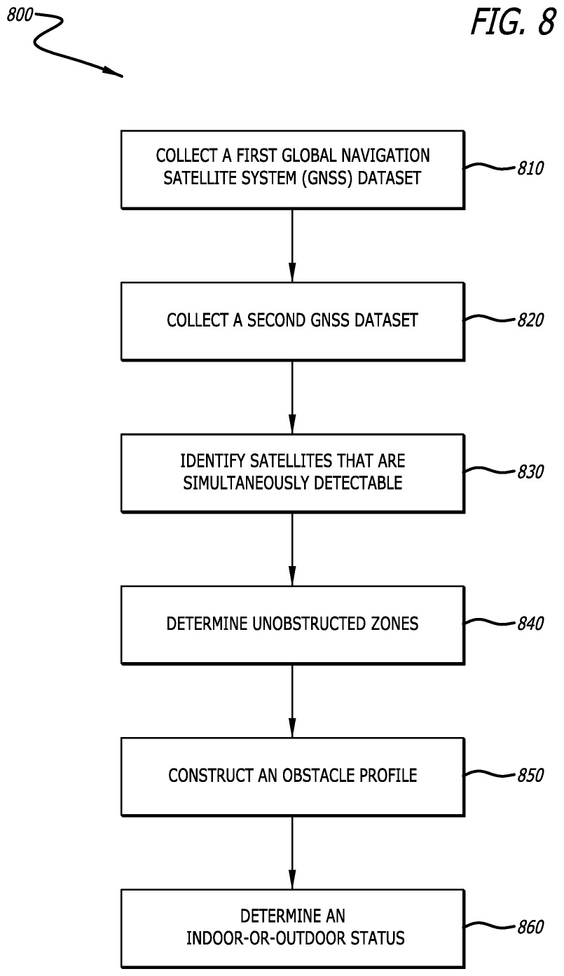

Referring to FIG. 8, a flowchart showing a process 800 for determining the indoor or outdoor status of a network device in accordance with various embodiments of the disclosure is shown. In many embodiments, the process 800 may collect a first GNSS dataset (block 810). In a number of embodiments, the first GNSS dataset can be from a first network device. In a variety of embodiments, the first GNSS dataset may include various types of data related to the GNSS signals received by the first network device, such as, but not limited to, indications of detectable GNSS satellites, timestamps, signal attributes (e.g., C/N0 for one or more GNSS bands), the number of observable satellites, pseudorange measurement noise statistics, and/or pseudorange residuals. In some embodiments, the collection of the first GNSS dataset may be performed continuously or at specific intervals, and the data can be stored for immediate or future analysis.

In more embodiments, the process 800 may collect a second GNSS dataset (block 820). In additional embodiments, the second GNSS dataset can be similar to the first dataset but related to a second network device. In further embodiments, the second network device may be located at a different position from the first network device. The difference in the GNSS data collected by the two network devices can provide data about the environment around the devices.

In still more embodiments, the process 800 may identify satellites that are simultaneously detectable (block 830). In still further embodiments, this can involve comparing the first and second GNSS datasets to identify the satellites that are detectable by both network devices at the same time. The simultaneously detectable satellites may provide data about the unobstructed zones around the two network devices.

In still additional embodiments, the process 800 may determine unobstructed zones (block 840). In some more embodiments, this can involve analyzing the locations of the simultaneously detectable satellites to determine zones not blocked by obstacles, where the determined unobstructed zones may enable the two network devices to detect the satellites simultaneously. In certain embodiments, the determination of the unobstructed zones may be based on triangulation techniques and a distance between the two network devices. In yet more embodiments, the distance between the two network device may be determined based on a ranging technique.

In still yet more embodiments, the process 800 may construct an obstacle profile (block 850). In many further embodiments, this can involve combining the data about the unobstructed zones to create a profile that represents the distribution of obstacles around and between the network devices. In many additional embodiments, the obstacle profile may provide a representation of the environment around the network devices.

In still yet further embodiments, the process 800 may determine an indoor-or-outdoor status (block 860). In still yet additional embodiments, the determination of the indoor-or-outdoor status can be based on the obstacle profile. By way of non-limiting examples, if the obstacle profile indicates significant obstacle(s) blocking the sky, the first network device and/or the second network device may be determined to be indoors; on the other hand, if the obstacle profile indicates few or no obstacles around and between the two network devices, the first network device and/or the second network device can be determined to be outdoors.

Although a specific embodiment for determining the indoor or outdoor status of a network device suitable for carrying out the various steps, processes, methods, and operations described herein is discussed with respect to FIG. 8, any of a variety of systems and/or processes may be utilized in accordance with embodiments of the disclosure. For example, the process can be adapted to incorporate a time factor, analyzing changes in the GNSS datasets and obstacle profiles over time to account for dynamic environments and moving obstacles. The elements depicted in FIG. 8 may also be interchangeable with other elements of FIGS. 1-7 and 9 as required to realize a particularly desired embodiment.

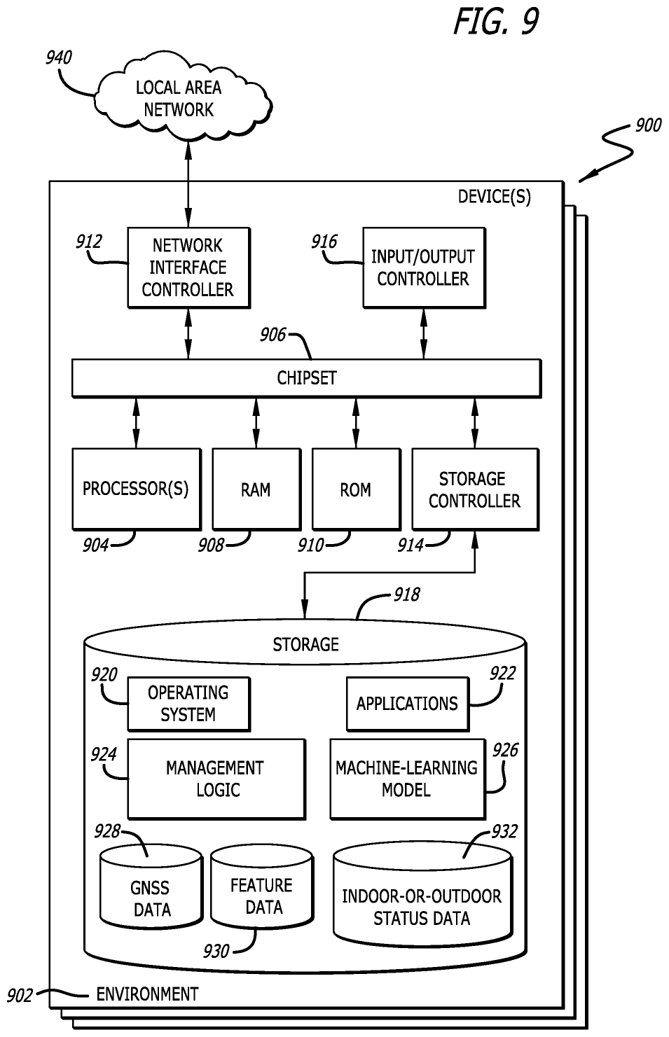

Referring to FIG. 9, a conceptual block diagram for one or more devices 900 capable of executing components and logic for implementing the functionality and embodiments described above is shown. The embodiment of the conceptual block diagram depicted in FIG. 9 can illustrate a conventional server computer, workstation, desktop computer, laptop, tablet, network appliance, e-reader, smartphone, or other computing device, and can be utilized to execute any of the application and/or logic components presented herein. The device 900 may, in some examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In additional embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Different embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for example, store an operating system 920, applications 922, GNSS data 928, feature data 930, and indoor-or-outdoor status data 932, which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In various embodiment, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In more embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9, and can include other components that are not explicitly shown in FIG. 9, or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

In many embodiments, the device 900 can include a management logic 924. The management logic 924 may be responsible for coordinating the various operations involved in determining the indoor or outdoor status of a network device. This can include managing the collection of GNSS datasets, the identification of detectable satellites, the construction of obstacle profiles, and/or the application of the machine learning process or other algorithms to make the final indoor-or-outdoor status determination.

In a number of embodiments, the storage 918 can include GNSS data 928. The GNSS data 928 may include various attributes such as indications of detected GNSS satellites, timestamps, almanac data, ephemeris data, the number of observable satellites, the number of decodable satellites, signal attributes (e.g., C/N0 for one or more GNSS bands such as, but not limited to, L1 and/or L5), pseudorange measurement noise statistics (e.g., GPGST_RMS), and/or pseudorange residuals. The GNSS data 928 can be generated by a GNSS receiver/sensor of a network device, and may be processed by the network device and/or transmitted to another device for further processing.

In various embodiments, the storage 918 can include feature data 930. The feature data 930 may represent a subset of the collected GNSS data that is potentially usable for determining the indoor-or-outdoor status of a network device. The feature data 930 can include attributes or patterns within the GNSS data, such as, but not limited to, the number of decodable satellites, signal attributes (e.g., C/N0 for one or more GNSS bands such as, but not limited to, L1 and/or L5), pseudorange measurement noise statistics (e.g., GPGST_RMS), pseudorange residuals, the number and/or indications of detectable satellites, signal strength, or angle ranges. The features data 930 may be particularly relevant for distinguishing between indoor and outdoor environments.

In still more embodiments, the storage 918 can include indoor-or-outdoor status data 932. The indoor-or-outdoor status data 932 may represent the final determination of whether a network device is located indoors or outdoors. The indoor-or-outdoor status data 932 can also indicate, by way of non-limiting examples, that the network device is in a partially covered environment, or that the network device is in an indoor environment with one or more windows. The determination can be made based on the analysis of the collected GNSS data, identified features, and other suitable factors. The indoor-or-outdoor status data 932 can be used to adjust the operation of the network device or for other purposes. By way of a non-limiting example, a network device (e.g., an AP) rated for indoor operation may be disabled if the network device is determined to be in an outdoor environment.

Finally, in many embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926. The ML model 926 may be configured to determine whether the network device is located indoors or outdoors based on the collected GNSS data.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
at least one network interface controller configured to provide access to a network; and
a memory communicatively coupled to the processor, wherein the memory comprises a management logic that is configured to:
collect a first global navigation satellite system (GNSS) dataset associated with a first network device; and
determine an indoor-or-outdoor status of the first network device based on the collected first GNSS dataset.

2. The network device of claim 1, wherein to determine the indoor-or-outdoor status of the first network device, the management logic is further configured to identify one or more features in the collected first GNSS dataset, and the indoor-or-outdoor status of the first network device is determined based on applying a machine learning process to the identified one or more features.

3. The network device of claim 2, wherein the one or more features comprise one or more of a signal attribute, a carrier-to-noise density ratio (C/N0), a number of observable satellites, a number of decodable satellites, pseudorange measurement noise statistics, or a pseudorange residual.

4. The network device of claim 2 wherein the machine learning process is associated with a model.

5. The network device of claim 4, wherein the model comprises a classifier.

6. The network device of claim 4, wherein the model is pretrained based on supervised learning.

7. The network device of claim 4, wherein the model is pretrained based on unsupervised learning.

8. The network device of claim 4, wherein the management logic is further configured to update the model based on locally collected data.

9. The network device of claim 1, wherein to determine the indoor-or-outdoor status of the first network device, the management logic is further configured to determine zero, one, or more angle ranges within which at least one satellite is detectable at the first network device based on the collected first GNSS dataset, and the indoor-or-outdoor status of the first network device is determined based on the zero, one, or more angle ranges.

10. The network device of claim 9, wherein the determined indoor-or-outdoor status of the first network device comprises an outdoor environment status if the zero, one, or more angle ranges comprises at least one angle range that satisfies a criterion.

11. The network device of claim 9, wherein the determined indoor-or-outdoor status of the first network device comprises an indoor environment status if the zero, one, or more angle ranges comprises one or more angle ranges a widest of which is less than a threshold.

12. The network device of claim 9, wherein the determined indoor-or-outdoor status of the first network device comprises an indoor environment status if the zero, one, or more angle ranges comprises zero angle range.

13. The network device of claim 1, wherein to determine the indoor-or-outdoor status of the first network device, the management logic is further configured to:
collect a second GNSS dataset associated with a second network device;
identify one or more satellites that are simultaneously detectable by the first network device and the second network device based on the collected first GNSS dataset and the collected second GNSS dataset, each of the one or more satellites being simultaneously detectable by the first network device and the second network device over a respective period of time;
determine one or more unobstructed zones based on each of the one or more satellites being simultaneously detectable by the first network device and the second network device; and
construct an obstacle profile based on a plurality of unobstructed zones, the plurality of unobstructed zones comprising the one or more unobstructed zones determined based on each of the one or more satellites,
wherein the indoor-or-outdoor status of the first network device is determined based on the constructed obstacle profile.

14. The network device of claim 13, wherein based on each of the one or more satellites being simultaneously detectable by the first network device and the second network device, the one or more unobstructed zones are determined based further on satellite location data, a distance between the first network device and the second network device, and a triangulation technique.

15. The network device of claim 14, wherein the distance between the first network device and the second network device is based on a radio frequency ranging measurement between the first network device and the second network device.

16. The network device of claim 13, wherein the obstacle profile is constructed based further on one or more first satellites that are successively but not simultaneously detectable by the first network device and the second network device.

17. The network device of claim 1, wherein the network device and the first network device are co-located at a same device.

18. The network device of claim 1, wherein the network device and the first network device are separate devices.

19. A network device, comprising:
a processor;
at least one network interface controller configured to provide access to a network; and
a memory communicatively coupled to the processor, wherein the memory comprises a management logic that is configured to:
collect a first global navigation satellite system (GNSS) dataset associated with a first network device;
identify one or more features in the collected first GNSS dataset; and
determine an indoor-or-outdoor status of the first network device based on applying a machine learning process to the identified one or more features.

20. A method for managing a network device, comprising:
collecting a first global navigation satellite system (GNSS) dataset associated with the network device; and
determine an indoor-or-outdoor status of the network device based on the collected first GNSS dataset.
